(19) United States
(12) Patent Application Publication
(10) Pub. No.: US 2021/0229499 A1
(43) Pub. Date: Jul. 29, 2021

(54) TEXTILE CORD AND A TIRE COMPRISING A TEXTILE CORD REINFORCEMENT

(71) Applicants: THE GOODYEAR TIRE & RUBBER COMPANY, Akron, OH (US); KORDSA TEKNIK TEKSTIL A.S., Izmit/ Kocaeli (TR)

(72) Inventors: Raphael Beck, Reichlange (LU); Dirk Lothar Maria van Eck, Rodgau (DE); Olivier Marcel Eugène Durand, Domérat (FR); Sébastien Montet, Michelau (LU); Gary Terence Barrett, Sutton Coldfield (GB); Mehmet Saadettin FIDAN, Izmit/Kocaeli (TR); Hazal ÖZCAN, Izmit/Kocaeli (TR); Neslihan GÜL, Izmit/Kocaeli (TR)

(21) Appl. No.: 17/155,273

(22) Filed: Jan. 22, 2021

Related U.S. Application Data
(60) Provisional application No. 62/965,419, filed on Jan. 24, 2020.

(51) Int. Cl. B60C 9/00

(52) U.S. Cl. CPC B60C 9/0042; B60C 2200/04; B60C 2009/0092; B60C 9/0064

(57) ABSTRACT

This invention relates to a passenger car tire comprising a carcass having at least one carcass ply, a tread disposed radially outward of a crown region of the carcass, a belt with a plurality of belt plies arranged between the carcass and the tread, and an overlay structure covering the belt and comprising a helically wound overlay ply strip reinforced by at least one textile cord. The cord comprises from 6 to 10 polyamide monofilament plies having each a density from 300 to 470 dtex, wherein the monofilament plies are twisted together by between 1 and 2 twists per inch to form the cord.

This application claims benefit of U.S. Provisional Patent Application Ser. No. 62/965,419, filed on Jan. 24, 2020. The teachings of U.S. Provisional Patent Application Ser. No. 62/965,419 are incorporated herein by reference in their entirety.

### FIELD OF THE INVENTION

The present invention is directed to a tire comprising a textile cord reinforcement, in particular in a ply or ply strip. Moreover, the present invention is directed a textile cord.

### BACKGROUND OF THE INVENTION

While tire performance has significantly improved over the course of the past few decades, the demands of the customers have increased as well, especially in the field of race tires. In particular, increasing requirements in the Ultra Ultra High Performance (UUHP) segment are showing the limits of current overlay reinforcing materials which cover belt plies of the tire. Increasing demands are for instance found in high speed performance, durability and/or handling. Preferable cords, which may help to achieve acceptable properties, in particular in overlay plies or ply strips, are known in the prior art. For instance, United States Patent Application Publication No. 2004/0118499 A1 discloses a pneumatic tire having an overlay strip comprising hybrid cords consisting of aramid yarn and a Nylon yarn twisted together to form a cord. While such solutions have helped to increase the performance of race tires, there is still significant room for further improvement.

U.S. Pat. No. 3,638,706 discloses a pneumatic tire reinforcement element comprising a single bundle of continuous macrofilaments of synthetic polymeric material selected from the group consisting of polyester and polyamide, wherein each macrofilament has a denier in the range 100 to 1,500, and the bundle has a total denier of 1,000 to 10,000 and a twist level not exceeding 4 turns per inch. According to U.S. Pat. No. 3,638,706 the preferred range of macrofilament denier is 200 to 700, desirably 400 to 600, and the total denier of the yarn is preferably in the range 2,000 to 5,000. It is preferable for each macrofilament in the yarn to be of the same denier. U.S. Pat. No. 3,638,706 further indicates that although the number of macrofilaments forming the yarn is variable, for a given total yarn denier, it is preferred that the number of macrofilaments should be at least three and not greater than 20, and desirably should be seven. Therefore, according to a preferred embodiment of U.S. Pat. No. 3,638,706, a synthetic filamentary yarn comprises seven synthetic macrofilaments, each of which has the same denier in the range 400 to 600, and the yarn has inserted therein about 2 turns per inch twist.

### SUMMARY OF THE INVENTION

A first object of the invention may be to provide cords or a tire comprising such cords in a reinforced ply or ply strip which support improvements in one or more tire properties including high speed capability, durability, cornering force, and ride and handling characteristics.

Another object of the invention may be to provide a tire comprising an improved tire overlay textile reinforcement.

Another object of the invention may be to provide an improved race or passenger car tire.

In one aspect of the invention, a passenger car tire is provided, the tire having a carcass comprising at least one carcass ply; a tread disposed radially outward of a crown region of the carcass; a belt with a plurality of belt plies arranged between the carcass and the tread; an overlay structure covering the belt and comprising a helically wound overlay ply strip reinforced by at least one cord, in particular textile cord. The cord comprises from 6 to 10 polyamide monofilament plies (or just monofilaments) having each a density from 300 dtex to 470 dtex, wherein the monofilament plies are twisted together by between 1 and 2 twists per inch to form the cord. For instance, the cord can have a density which is within the range of 300 dtex to 420 dtex or which is within the range of 320 dtex to 400 dtex. In another embodiment the cord can have a density which is within the range of 450 dtex to 470 dtex or which is within the range of 455 dtex to 460 dtex. The monofilament plies typically are twisted together using from 1 to 1.8 twists per inch to from the cord. In one embodiment of this invention the monofilament plies typically are twisted together using from 1 to 1.8 twists per inch or from 1.2 to 1.6 twists per inch to from the cord.

In particular, the strip could be a jointless band (JLB) strip with parallel cords. This construction has proven to be of particular value in race car applications and is also applicable in the field of passenger car tires. Amongst others, such a cord has a high bending stiffness, in particular in comparison to multifilament cords. The same applies to flex-fatigue resistance. It has also shown improvements in cornering stiffness which helps to reduce lap times for racing cars having tires equipped with such technology. Twist levels which are higher than the claimed range have been found to result in high internal torques which cause a non-uniform cord distribution leading to variable cord-to-cord distances (rivet), thus facilitating crack initiation and ply separation and thereby impairing tire durability. Apart from that higher twist levels result in a drop of breaking strength and modulus which negatively affect ply strength and stiffness, leading to a reduction in tire performance. If in contrast the twist levels are lower than the desired range, under compression, the low twist cord is subjected to cord-ply separation (bird-cage formation) leading to a cord-to-cord contact and potential cord breaking. The term monofilament ply may be understood herein as a ply consisting of one monofilament, i.e. a monofilament.

In one embodiment of the present invention, the cord comprises from 7 to 9 monofilament plies. Such a relatively high number of monofilament plies has proven to be desirable, giving for instance more stiffness (especially bending stiffness) to the construction. It should be noted that 7 monofilament plies may be of particular interest due to their compact and relatively symmetric construction. Monofilament plies may have an essentially circular or a circular cross section.

In another embodiment, each monofilament ply has a linear density which is within the range of 400 dtex to 460 dtex. Cords with ply linear densities lower than 400 dtex have limited bending stiffness, and linear densities higher than 460 dtex are deemed less suitable from the viewpoint of reduced fatigue resistance.

In yet another embodiment, the monofilament plies are twisted together with 1 to 1.5 twists per inch (tpi). They may also be twisted together with less than 1.4 twists per inch. Apart from the already above mentioned reasons for a limited range of twist levels, such cords with even lower twist level are particularly suitable for an advanced adhesive dip penetration into the monofilament bundle. Such a dip penetration improves flex fatigue resistance of the cords.

In one embodiment of this invention, the polyamide material can be a polyamide (nylon), such as Nylon 6.6.

In another embodiment, the diameter of a monofilament ply is within the range of 0.15 mm to 0.3 mm, and is preferably within the range of 0.2 mm to 0.23 mm. This range further optimizes the fatigue resistance and bending stiffness.

In still another embodiment, the maximum diameter of the cord is less than 0.7 mm, preferably is within the range of 0.62 mm to 0.68 mm. In particular, such a maximum value enables weight and rolling resistance reduction.

In still another embodiment, the cord is coated with an adhesive, optionally with a resorcinol-formaldehyde-latex (RFL) adhesive. Such an adhesive may improve the connection, respectively adhesion, between the cords and the rubber matrix.

In yet another embodiment, the cord has a construction of 460/7 dtex nylon with 1.1 to 1.4 twists per inch, optionally about 1.3 twists per inch. Such a construction has been identified as one preferred example.

In general, multiple of the embodiments, or features thereof as mentioned herein, may be combined with one another.

In another embodiment, the tire is type approved, designed or certified to drive faster than 300 km/h or has a speed index of “W”, “Y” or “(Y)”.

In another embodiment, the tire is a slick or semi slick tire.

In another embodiment, the tire has a size of within the following range: 285-350/50-80, 17-22 inch, such as 305/68 R18 or 310/71 R18.

In another embodiment, the tire is a pneumatic tire.

In still another embodiment, the overlay ply strip extends over the belt plies at an angle of between 0° and 5° with the equatorial plane of the tire. Such a strip has turned out to be a preferred way to build the overlay for passenger car or race tires as described herein.

In yet another embodiment, the tire has a ply or ply strip comprising a plurality of the cords with from 10 to 50 ends per inch (epi), optionally between 20 and 40 ends per inch or even more preferably between 25 and 35 ends per inch. In other words, an end can be considered as a cord end. In any case, that manner of notation is known to persons having ordinary skill in the tire art. The cords are typically arranged in parallel, preferably in a plane beside one another in the strip. The number or density of ends per inch is measured perpendicular to the extension of the cords and/or the strip as known to the person skilled in the art.

In another embodiment, said strip has one or more of: a width (w) in the range of 5 mm to 20 mm, preferably between 5 mm and 16 mm, a thickness (t) in the range of 0.4 mm to 5 mm, preferably between 0.6 mm and 5 mm or even 0.6 mm to 1 mm.

In still another embodiment, the tire is a pneumatic race car tire.

In another aspect, the present invention is directed to a cord or tire cord, in particular a cord for an overlay ply strip of a tire. The cord may have the features and/or properties already described above in relation to one or more aspects and/or embodiments of the tire.

In general, the features of the above mentioned aspects, embodiments and/or the description as recited hereinbelow may be combined with one another.

### BRIEF DESCRIPTION OF THE DRAWINGS

The structure, operation and advantages of the invention will become more apparent upon contemplation of the following description taken in conjunction with the accompanying drawings, wherein:

FIG. 1 represents a perspective partial cross-section of a tire in accordance with an embodiment of the invention.

FIG. 2 represents a schematic cross-section of a ply strip, e.g. an overlay ply strip, comprising schematically displayed cords in accordance with the invention.

FIG. 3 represents a schematic cross section of a cord for a tire ply or ply strip in accordance with an embodiment of the invention.

### DETAILED DESCRIPTION OF THE INVENTION

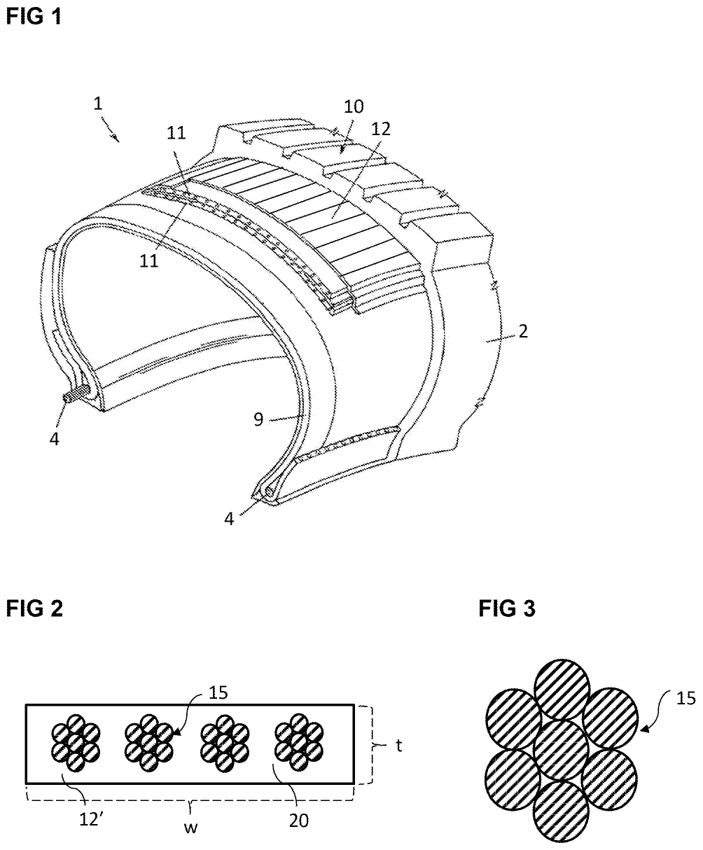

FIG. 1 is a schematic perspective cross-section of a tire 1. The tire 1 has a tread 10, a belt structure comprising two belt plies 11, a carcass ply 9, two sidewalls 2, and two bead regions comprising beads 4. The example tire 1 is suitable, for example, for mounting on a rim of a vehicle, e.g. a passenger car. As mentioned already above, the term passenger car tire shall include also race car tires. As shown in FIG. 1, the belt plies 11 may be covered by an overlay ply 12. The overlay ply 12 is schematically shown as a helically wound ply strip similar to strip 12′ schematically shown in FIG. 2. The overlay 12 may also be formed by multiple of such strips 12, 12′. In other words, one or more ply strips 12, 12′ may be wound essentially in a circumferential direction, for instance with an angle of between 0° and 5° with the equatorial plane of the tire (or, in other words, with respect to the circumferential centerline of the tire), covering the radially outermost belt ply 11 radially below the tread 10. The carcass ply 9 of FIG. 1 includes a pair of axially opposite end portions, each of which is associated with a respective one of the beads 4. Each axial end portion of the carcass ply may be turned up and around the respective bead 4 to a position to anchor each axial end portion. One or more of the carcass plies 9, belt plies 11, overlay ply strip(s) 12, 12′ comprise a rubber composition (such compositions are known in the tire art and are not within the focus of the present invention) and have a plurality of substantially parallel reinforcing members, or in other words textile cords, in accordance with an example of the invention. As further shown in FIG. 1, the example tread 10 may have five circumferential grooves, each groove essentially defining a U-shaped opening in the tread 10. The main portion of the tread 10 may be formed of one or more tread compounds, which may be any suitable tread compound or compounds.

While the embodiment of FIG. 1 suggests a plurality of tire components not all of those are mandatory for the invention. For instance, the turned-up ends of the carcass ply 9 are not necessary for the invention or may pass on the opposite sides of the respective beads 4 and terminate on the axially inner sides of the respective beads 4 instead of the axially outer side of the beads 4. The tire could also have for instance more or less than five grooves or even no grooves, as also possible in race car tires having slick treads. Moreover, the tire 1 shown in FIG. 1 has two belt plies 11. However, it could have more belt plies 11, for instance three or four or even five or more belt plies. One belt ply is also an option.

The schematic cross-section of FIG. 2 shows the ply strip 12′, e.g. an overlay ply strip 12′ which comprises a plurality of cords 15 reinforcing the rubber composition material 20. Typically, such a ply strip may be made in a fabric calendar unit in which a plurality of essentially parallel textile/fabric cords are coated from both sides with a layer or sheet of rubber composition 20. Such coating methods are well known to the person skilled in the art of tire building. After curing, the cords 15 are embedded in the rubber composition 20, reinforcing the same.

In general, cords 15 may be coated with dips and/or adhesives (or may be free of such materials) for better adhesion properties with regards to adhesion of the cords 15 to the rubber composition or matrix 20. Neither a dip nor an adhesive coating is shown in FIG. 2.

While the schematic drawing of FIG. 2 indicates four cords 15 according to an embodiment of the invention, the number of parallel cords per ply strip could be different, for instance between 2 and 10. A preferred ends per inch (epi) value could be between 10 and 40 epi, in particular 30 epi. The width w of the ply strip 12′ may be for instance in general in the range from 3 to 15 mm, preferably from 4 to 15 mm. The thickness t could be for instance in the range from 0.5 to 3 mm. In general, the width w of the strip 12′ (essentially in parallel to the axial direction of the tire) is larger than the thickness t of the strip 12′ (essentially measured in the radial direction of the tire). The cords 15 extend in parallel to the length of the strip 12′ (essentially perpendicular to the width w and thickness direction t). Ends per inch can be suitably measured in parallel to the width and perpendicular to the length of a strip or perpendicular the direction of extension of the cords.

FIG. 3 discloses a schematic cross section of a cord 15 comprising seven polyamide monofilament plies (or in other words monofilament fibers or just monofilaments). Although it may seem at a first glance that the cord 15 has a core monofilament ply, it is emphasized that all 7 monofilament plies are twisted together. The cord 15 does not have a core or central monofilament ply with other monofilaments plies wrapped around such a central core. In contrast, the seven monofilament plies are twisted around each other to form the cord 15 within the scope of an embodiment of the present invention.

Variations in the present invention are possible in light of the provided description. While certain representative embodiments, examples and details have been shown for the purpose of illustrating the subject invention, it will be apparent to those skilled in this art that various changes and modifications can be made therein without departing from the scope of the invention. It is, therefore, to be understood that changes may be made in the particular example embodiments described which will be within scope of the invention as defined by the appended claims.

Optionally, the terms “tire ply” and “ply strip” may also be considered as “tire cap ply” (or just “cap ply”) and “cap ply strip”, respectively.

In any case, the above described embodiments and examples shall not be understood in a limiting sense. In particular, the features of the above embodiments may also be replaced or combined with one another.

What is claimed is:

1. A tire comprising: (1) a carcass comprising at least one carcass ply; (2) a tread disposed radially outward of a crown region of the carcass; (3) a belt with a plurality of belt plies arranged between the carcass and the tread; (4) an overlay structure covering the belt and comprising a helically wound overlay ply strip reinforced by at least one cord; wherein the cord comprises from 6 to 10 polyamide monofilament plies having each a density which is within the range of 300 dtex to 470 dtex, and wherein the monofilament plies are twisted together with the number of turns per inch to form the cord being within the range of 1 to 2 twists per inch.

2. The tire of claim 1 wherein the cord comprises from 7 to 9 monofilament plies, wherein each monofilament ply has a density from 400 dtex to 460 dtex, and wherein the monofilament plies are twisted together by between 1 and 1.5 twists per inch.

3. The tire of claim 1 wherein the monofilament plies are twisted together by less than 1.4 twists per inch.

4. The tire of claim 1 wherein the cord comprises seven monofilament plies.

5. The tire of claim 1 wherein the polyamide is a nylon.

6. The tire of claim 1 wherein the monofilament plies have an essentially circular cross section.

7. The tire of claim 1 wherein the diameter of each monofilament ply is within the range of 0.15 mm to 0.3 mm.

8. The tire of claim 1 wherein the maximum diameter of the cord is less than 0.7 mm.

9. The tire of claim 1 wherein the cord is coated with a resorcinol-formaldehyde-latex adhesive.

10. The tire of claim 1 wherein the cord has a construction of 460/7 dtex Nylon with 1.1 to 1.4 twists per inch.

11. The tire of claim 1 wherein the tire is a passenger car tire wherein the tire is type approved to be driven at a speed of faster than 300 km/h.

12. The tire of claim 1 wherein the tire is a passenger cars tire having a speed index of “W”, a speed index of “Y”, or a speed index of “(Y)”.

13. The tire of claim 1 wherein the tire is a slick or semi slick tire.

14. The tire of claim 1 wherein the helically wound overlay ply strip extends over the belt plies at an angle of between 0° and 5° with respect to the equatorial plane of the tire.

15. The tire of claim 1 wherein the ply strip has 10 to 50 ends per inch.

16. The tire of claim 1 wherein said strip has a width (w) which is within the range of 5 mm to 20 mm or a thickness (t) which is within the range of 0.4 mm to 4 mm.

17. A cord for a tire overlay ply strip, the cord comprising from 6 to 10 polyamide monofilament plies having each a density from 300 dtex to 470 dtex, wherein the monofilament plies are twisted together by with 1 to 2 twists per inch to form the cord, wherein the cord comprises from 7 to 9 monofilament plies.

18. The cord of claim 17 wherein the monofilament plies are twisted together with 1 to 1.5 twists per inch.

19. The cord of claim 17 wherein the diameter of each monofilament ply is within the range of 0.15 mm to 0.3 mm.

20. The cord of claim 17 wherein the cord is coated with a resorcinol-formaldehyde-latex adhesive.
